(19) United States
(12) Patent Application Publication
(10) Pub. No.: US 2014/0321271 A1
(43) Pub. Date: Oct. 30, 2014

(54) SIGNAL REDUCTION BASED ON RADIO LOAD

(71) Applicant: TELEFONAKTIEBOLAGET L M ERICSSON (PUBL), Stockholm (SE)

(72) Inventors: STAFFAN BONNIER, ASKIM (SE); SAMY TOUATI, PLEASANTON, CA (US); MATTIAS WAHLQVIST, MADRID (ES)

(73) Assignee: Telefonaktiebolaget L M Ericsson (publ), Stockholm (SE)

(21) Appl. No.: 13/869,638

(22) Filed: Apr. 24, 2013

(51) Int. Cl. H04W 28/02

(52) U.S. Cl. CPC H04W 28/0215
USPC 370/230

(57) ABSTRACT

According to one embodiment, a packet data network gateway (PDN-GW) receives a UE congestion status message originating from an eNodeB indicating a UE is congested. In one embodiment, the PDN-GW receives a request message from a policy charging and rules function (PCRF) to create a new policy and charging control (PCC) rule for the UE. The PDN-GW discards the request message to prevent a request to create/modify a bearer for the UE from being sent by the PDN-GW, and prevent a response message denying the request message to create/modify the bearer for the UE from being sent by the eNodeB, reducing the number of bearer creation or modification messages being exchanged in the EPS.

According to one embodiment, an Evolved Node B (eNodeB) determines that a UE communicatively coupled to the eNodeB is congested, and sends a UE congestion status message destined for the PDN-GW.

### FIELD

Embodiments of the present invention relate generally to packet networks. More particularly, this invention relates to a method for reducing the number of messages being exchanged in a network.

### BACKGROUND

3rd Generation Partnership Project (3GPP) Release 8 and later defines the Evolved Packet System (EPS) that includes the Evolved UMTS Terrestrial Radio Access Network (E-UTRAN) and the Evolved Packet Core (EPC). The EPS provides a new Quality of Service (QoS) model based on dedicated bearers. In this model, a dedicated bearer may be established in order to deliver a certain Service Delivery Flow with certain QoS guarantees. Establishment of a dedicated bearer is initiated by the PDN-GW. Typically, the PDN-GW is triggered to initiate a dedicated bearer by a request from the Policy Control and Rules Function (PCRF) over the Gx interface. The PCRF, in turn, typically is triggered by a request from the Service Provider over the Rx interface or a non-standard interface.

Alternatively, a Traffic Detection Function located at the PDN-GW may detect the type of service (e.g., using Deep Packet Inspection) being used over the SGi interface and sends a request over Sd to the PCRF based on the detected type of service. In response, the PCRF may trigger the PDN-GW over the Gx interface to initiate a dedicated bearer.

Once the PDN-GW has initiated the creation of a new bearer, the request is propagated via the Serving Gateway (SGW) and the Mobility Management Entity (MME) to the E-UTRAN. The E-UTRAN may or may not honor the request. For instance, thee-UTRAN may determine whether or not to grant the request to create a new dedicated bearer based on the requested radio resources and the current radio load situation. In circumstances where radio resources cannot be allocated, the E-UTRAN rejects the request. The rejection is eventually propagated back to the PCRF and from there to the Service Provider that initiated the request.

Based on the conventional model described above, the PDN-GW always signal (i.e., send) messages to the E-UTRAN to initiate the creation of a dedicated bearer even if the radio load situation does not permit the creation of the new dedicated bearer because the PDN-GW does not have knowledge of the radio load situation.

### SUMMARY

Exemplary methods, apparatuses, and systems include receiving a first UE congestion status message originating from a first eNodeB of a plurality of eNodeBs, the first UE congestion status message indicating a first UE of the plurality of UEs is congested. In one embodiment, the exemplary methods, apparatuses, and systems include receiving a first request message from a PCRF to create a new policy and charging control (PCC) rule for the first UE. In one embodiment, the exemplary methods, apparatuses, and systems include discarding the first request message at the PDN-GW to prevent a first request message to create or modify a bearer for the first UE from being sent by the PDN-GW destined for the first eNodeB, and prevent a first response message denying the first request message to create or modify the bearer for the first UE from being sent by the first eNodeB destined for the PDN-GW, reducing a number of bearer creation or modification messages being exchanged in the EPS, in response to receiving the first UE congestion status message. In one embodiment, the exemplary methods, apparatuses, and systems include updating a data context data structure located at the PDN-GW to indicate the first UE is congested, in response to receiving the first UE congestion status message. In one embodiment, discarding the first request message comprises determining that an Internet Protocol (IP) address of the first UE exists in the data context data structure, and a corresponding congestion status bit in the data context data structure contains a bit value indicating the first UE is congested.

Exemplary methods, apparatuses, and systems include determining that a first UE of the plurality of UEs communicatively coupled to an eNodeB is congested and sending a first UE congestion status message destined for the PDN-GW, the first UE congestion status message indicating the first UE is congested. In one embodiment, sending the first UE congestion status message includes generating a first Internet Protocol (IP) packet, wherein a congestion status of the first UE is contained in the first IP packet payload, and sending the first IP packet destined for the PDN-GW (230). In one aspect of the invention, sending the first UE congestion status message further includes generating a first GPRS Tunneling Protocol (GTP) packet, wherein a congestion status of the first UE is contained in a header field of the first GTP packet, and sending the first GTP packet destined for the PDN-GW (230).

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating a conventional 3GPP EPS 100.

FIG. 2 is a block diagram illustrating a 3GPP EPS 200, according to one embodiment.

FIG. 3 is a block diagram illustrating an eNodeB according to one embodiment.

FIG. 4 is a block diagram illustrating a PDN-GW according to one embodiment.

FIG. 5A is a flow diagram illustrating a method for reducing the number of messages in an EPS according to one embodiment.

FIG. 5B is a flow diagram illustrating a method for reducing the number of messages in an EPS according to one embodiment.

FIG. 6A is a flow diagram illustrating a method for sending UE congestion status according to one embodiment.

FIG. 6B is a flow diagram illustrating a method for sending UE congestion status according to one embodiment.

FIG. 7A is a flow diagram illustrating a method for sending UE congestion status according to one embodiment.

FIG. 7B is a flow diagram illustrating a method for sending UE congestion status according to one embodiment.

FIG. 8 is a flow diagram illustrating a method for maintaining UE congestion status at a PDN-GW according to one embodiment.

FIG. 9 is a flow diagram illustrating a method for reducing the number of messages exchanged in an EPS according to one embodiment.

FIG. 10 is a flow diagram illustrating a method for reducing the number of messages exchanged in an EPS according to one embodiment.

FIG. 11 is a flow diagram illustrating a method for sending UE congestion status according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

As used herein, a network interface may be physical or virtual; and an interface address is an IP address assigned to a network interface, be it a physical network interface or virtual network interface. A physical network interface is hardware in a network device through which a network connection is made (e.g., wirelessly through a wireless network interface controller (WNIC) or through plugging in a cable to a port connected to a network interface controller (NIC)). Typically, a network device has multiple physical network interfaces. A virtual network interface may be associated with a physical network interface, with another virtual interface, or stand on its own (e.g., a loopback interface, a point to point protocol interface). A network interface (physical or virtual) may be numbered (a network interface with an IP address) or unnumbered (an network interface without an IP address). A loopback interface (and its loopback address) is a specific type of virtual network interface (and IP address) of a node (physical or virtual) often used for management purposes; where such an IP address is referred to as the nodal loopback address. The IP address(es) assigned to the network interface(s) of a network device, are referred to as IP addresses of that network device; at a more granular level, the IP address(es) assigned to network interface(s) assigned to a node implemented on a network device, can be referred to as IP addresses of that node.

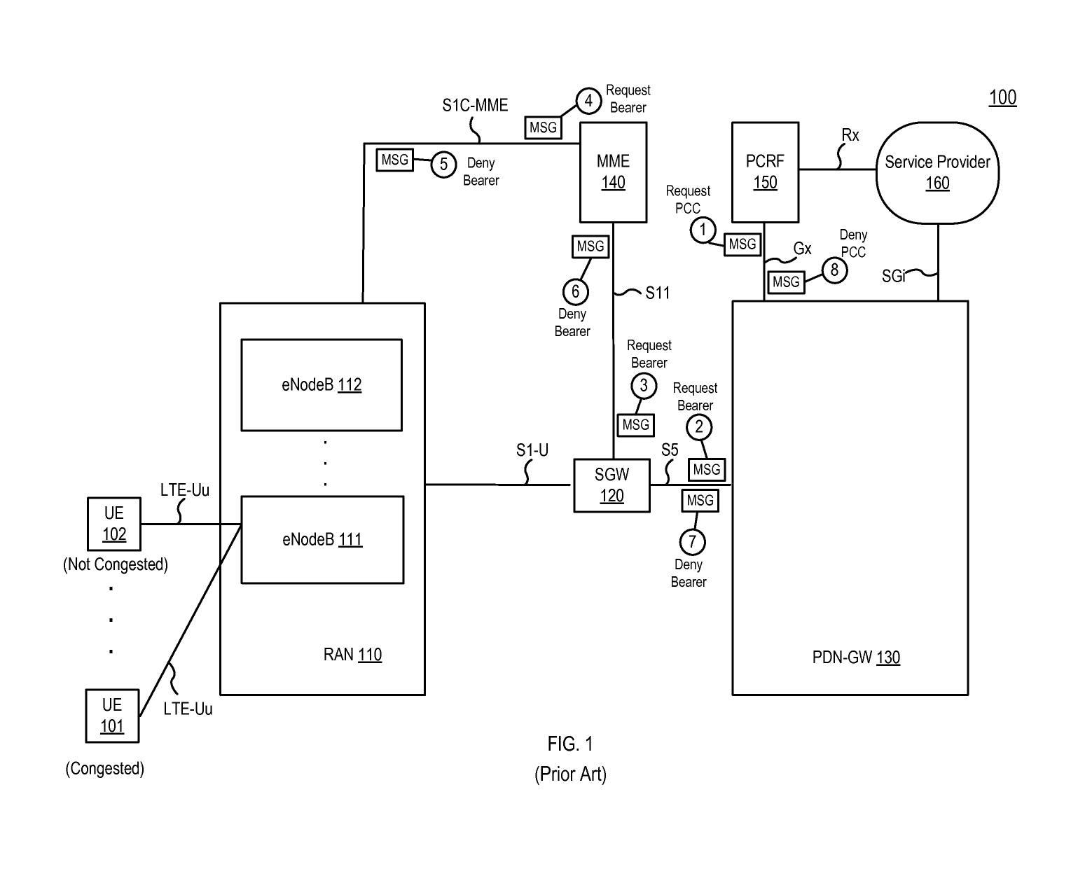

FIG. 1 is a block diagram illustrating a conventional EPS 100. Referring now to FIG. 1, EPS 100 is partitioned into sub networks based on functionality: one or more radio access networks (RANs) and a core network (CN). EPS 100, for example, includes one or more E-UTRANs which serve as RANs, such as RAN 110. The E-UTRANs shall herein be simply referred to as RANs. Each RAN includes one or more small cells, also commonly known as Evolved Node Bs (eNodeBs), such as eNodeBs 101-102. Each eNodeB is communicatively coupled to one or more user equipments (UEs), such as UE 101-102. UEs are communicatively coupled to the eNodeBs over the LTE-Uu interface. UEs 101-102 may be any variety of mobile devices, such as Smartphones, tablets, gaming devices, and/or media devices, etc.

EPS 100 also includes the EPC which serves as a core network. The EPC includes a SGW (e.g., SGW 120), a MME (e.g., MME 140), a PDN-GW (e.g., PDN-GW 130), and a PCRF (e.g., PCRF 150), and a Service Provider (e.g., Service Provider 160). Each RAN is communicatively coupled to the MME over the S1C-MME interface. Each RAN is communicatively coupled to the SGW over the S1-U interface. The MME and the SGW are communicatively coupled to each other over the S11 interface. The SGW is communicatively coupled to the PDN-GW over the S5 interface. The PDN-GW is communicatively coupled to the PCRF and the Service Provider over the Gx and SGi interfaces, respectively.

The eNodeBs are responsible for radio-related functions such as radio resource management, including, but is not limited to, radio bearer control, radio admission control, and radio mobility control. The eNodeBs are also configured to provide header compression of Internet protocol (IP) packets that are transmitted to/from the UEs to enable more efficient use of radio bandwidth.

The MME functions as a control node that is responsible for authenticating the UEs by invoking a home subscriber server (HSS) (not shown), which contains information such as the types of services the UEs are permitted to access. The MME also implements functions related to bearer management, e.g., establishing, maintenance, and release of the bearers established between the UEs and the SGW.

The SGW is responsible for routing user traffic to/from the UEs to the PDN GW, which in turn, routes user traffic to/from an external network such as the Internet. The SGW serves as a mobility anchor for the data bearers when UEs move from one eNodeB (i.e., small cell) to another. The PCRF is responsible for making policy control decisions. The PCRF provides QoS authorization that dictates how data flows are treated by the PDN-GW and ensures that the flow is in accordance with the user's subscription profile.

In an EPS, data is transported through bearers. Each bearer is associated with a particular quality of service (QoS), which defines connection parameters such as the data rate, error rate, delay, etc. Several types of bearers exist in the EPS. An end-to-end bearer, which exchanges information between a UE and a peer entity, e.g., the Internet. Alternatively, data can be exchanged between a UE and the peer entity through a combination of an EPS bearer and an external bearer. The EPS bearer exchanges information between a UE and the PDN-GW, and the external bearer exchanges information between the PDN-GW and the peer entity.

An EPS bearer spans across multiple interfaces, each interface using a different transport protocol. Thus, an EPS bearer cannot be implemented as a single bearer. Typically, an EPS bearer includes a radio bearer, a S1 bearer, and a S5/S8 bearer; the radio bearer exchanges data between a UE and an eNodeB through the LTE-Uu interface; the S1 bearer exchanges data between an eNodeB and the SGW through the S1-U interface; and, the S5/S8 bearer exchanges data between the SGW and the PDN-GW through the S5/S8 interface.

According to 3GPP specifications, there are several types of classifications of EPS bearers. For example, an EPS bearer may be classified as a guaranteed bit rate (GBR) bearer or a non-GBR bearer. Typically, a GBR bearer is desirable for connections that require a quality of service (QoS) that guarantees a certain minimum bit rate, e.g., voice over IP (VoIP) applications. An EPS bearer may also be classified as either a default bearer or a dedicated bearer. A default bearer is simply an EPS bearer that is established when the UE first attaches to the packet data network. The default bearer provides the user with an always-on IP connection to the network. The default bearer is always a non-GBR bearer. After the UE has attached to the network and the default bearer has been setup, the UE may, in some cases, establish additional EPS bearers (e.g., by requesting to view a video), known as dedicated bearers, which can be GBR or non-GBR, depending on the type of application for which the bearer is being setup.

Referring still to FIG. 1. We will now discuss a typical signaling (i.e., message exchanges) in a conventional EPS. In FIG. 1, each message is illustrated as a rectangular box with the label “MSG”. Each message is identified by an identifier (ID) (i.e., a number) in a circle. The message IDs indicate the sequence in which the messages are exchanged in the EPS. As described herein, a message and its corresponding ID shall be referenced as “MSG ID”.

In the following illustration, it is assumed that Service Provider 160 has detected a request from UE 101 to deliver data to UE 101, e.g., a high definition (HD) video streaming session. Service Provider 160, in turn, requests PCRF 150 over the Rx interface for authorization to deliver the data to UE 101. It is further assumed that eNodeB 111 has determined UE 101 is congested.

PCRF 150, in response to receiving the request from Service Provider 160, sends MSG 1 to PDN-GW 130 over the Gx interface requesting PDN-GW 130 to provision a new policy and control charging (PCC) rule for UE 101. For example, MSG 1 is a Re-Auth-Request (RAR) message.

PDN-GW 130, in response to receiving the request to provision a new PCC rule for UE 101 (i.e., MSG 1), initiates the creation or modification of a bearer for UE 101 by sending MSG 2 to SGW 120, which is propagated to MME 140 and eNodeB 111 as MSG 3 and MSG 4, respectively.

eNodeB 111, in response to receiving the request to create or modify a bearer for UE 101, determines whether the current radio load condition permits allocating the required radio resources. In this illustration, it is assumed that eNodeB 111 determines the radio load condition does not permit allocation of the requested radio resources, and sends MSG 5 to MME 140, rejecting the request for the creation or modification of a bearer. The denial message (i.e., MSG 5) is propagated to SGW 120 and PDN-GW 130 as MSG 6, and MSG 7, respectively.

PDN-GW 130, in response to receiving the bearer creation/modification message (i.e., MSG 7), sends MSG 8 back to PCRF 150, rejecting the request to provision a new PCC rule for UE 101. PCRF 150, in turn, denies Service Provider 160 the opportunity to deliver data (e.g., the HD video streaming session) to UE 101.

According to some embodiments of the invention, an architecture and set of mechanisms are provided to reduce the number of messages relating to bearer creation/modification (e.g., MSG 2 through MSG 7 of FIG. 1) from being exchanged in the EPS when a denial of the bearer is likely to occur due to the radio load condition. According to one embodiment, when an eNodeB determines that a UE is congested, the eNodeB sends the UE congestion status to the PDN-GW. The congestion status may be sent in-band (i.e., over the user plane) or out-band (i.e., over the control plane). In one embodiment, the PDN-GW receives the congestion status and stores the status in a data context data structure maintained locally at the PDN-GW. The data context data structure shall herein be referred to simply as data structure. In one embodiment, the PDN-GW stores the UE congestion status in the data structure by populating the data structure with an identifier identifying the UE and marking the UE as congested. A UE identifier may be the Internet Protocol (IP) address or an International Mobil Subscriber Identity (IMSI) of the UE. If the UE identifier already exists in the data structure (e.g., because the congestion status for the UE was previously received by the PDN-GW), the PDN-GW is configured to update the congestion status in the data structure, without populating the data structure with the same UE identifier at a new data structure entry.

According to one embodiment, when an eNodeB determines that a UE is not congested, the eNodeB sends the UE congestion status to the PDN-GW either in-band or out-band. In one embodiment, the PDN-GW updates the data structure based on the received UE congestion status, using similar mechanisms as those described above. In one aspect of the invention, the eNodeB is configured to send a congestion status message when the eNodeB detects a congestion status change for a UE (e.g., from not congested to congested, and vice versa).

According to one embodiment, when the PDN-GW receives a request from the PCRF to provision a new PCC rule for a UE, the PDN-GW determines whether the UE is congested by performing a lookup of the data structure. In one embodiment, the PDN-GW determines that the UE is congested if a UE ID identifying the UE exists in the data structure, and the UE is marked as congested in the data structure. In such an embodiment, the PDN-GW determines that the UE is not congested if the UE ID identifying the UE exists in the data structure and it is marked as not congested. In one embodiment, the PDN-GW determines that the UE is not congested if the data structure does not include a UE ID corresponding to the UE for which the new PCC provision is being requested.

According to one embodiment, the PDN-GW is configured to reject the request from the PCRF to provision a new PCC rule for the UE in response to determining the UE is congested based on information of the data structure. In such an embodiment, the PDN-GW effectively “discards” the request from the PCRF without sending any bearer creation/modification messages destined for the eNodeB that is communicatively coupled to the UE for which the new PCC rule is being requested. By suppressing the bearer creation/modification requests, the PDN-GW prevents the eNodeB from having to send bearer denial messages destined for the PDN-GW, thus reducing the number of messages being exchanged in the EPS. In one embodiment, the PDN-GW is configured to send bearer creation/modification messages destined for the eNodeB communicatively coupled to the UE in response to determining that the UE is not congested based on information of the data structure.

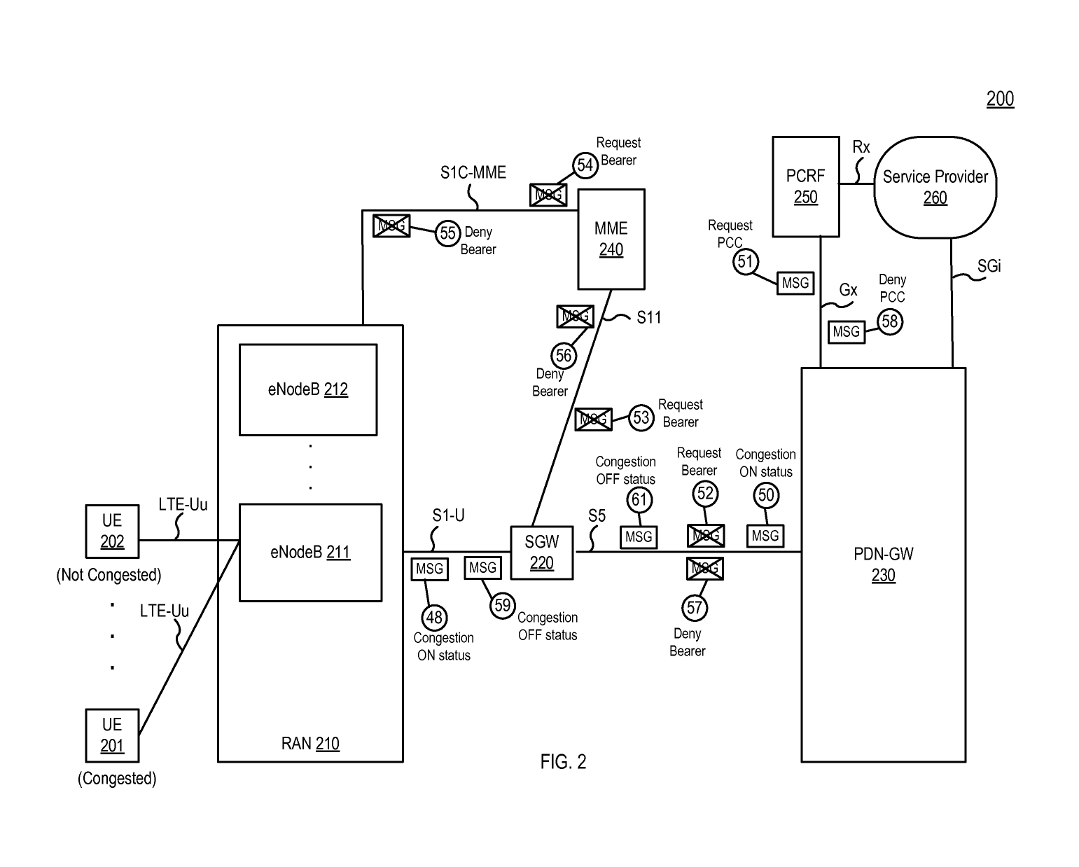

FIG. 2 is a block diagram illustrating an EPS 200 according to one embodiment of the invention. EPS 200 includes RAN 210 communicatively coupled to MME 240 and SGW 220 via the S1C-MME and S1-U interface, respectively. MME 240 is communicatively coupled to SGW 220 over S11 interface, and SGW 220 is communicatively coupled to PDN-GW 230 over S5 interface. PDN-GW 230 is communicatively coupled to PCRF 250 and Service Provider 260 over the Gx and SGi interface, respectively. PCRF 250 and Service Provider 260 are communicatively coupled over the Rx interface.

RAN 210 includes one or more eNodeBs, such as eNodeBs 211-212, each eNodeB communicatively coupled to one or more UEs over the LTE-Uu interface. For example, as illustrated in FIG. 2, eNodeB 211 is communicatively coupled to UEs 201-202.

The advantages of EPS 200 over the conventional EPS 100 can be best illustrated by comparing the messages exchanged in EPS 200 against the messages exchanged in EPS 100 in the same scenario described in the text relating to FIG. 1, which is repeated here for convenience. In the following illustration, it is assumed that Service Provider 260 has detected a request from UE 201 to deliver data to UE 201, e.g., a high definition (HD) video streaming session. Service Provider 260, in turn, requests PCRF 250 over the Rx interface for authorization to deliver the data to UE 201. It is further assumed that eNodeB 211 has determined UE 201 is congested.

In FIG. 2, an “X” mark over a message denotes that the message is not sent in the optimized EPS 200, but would have been sent in a conventional EPS (e.g., EPS 100). eNodeB 211, in response to determining UE 201 is congested, sends MSG 48 to SGW 220 indicating UE 201 is congested. MSG 48 is propagated from SGW 220 to PDN-GW 230 as MSG 50. In response to receiving MSG 50, PDN-GW 230 updates a local data structure to indicate UE 201 is congested.

PCRF 250, in response to receiving the request from Service Provider 260, sends MSG 51 to PDN-GW 230 over the Gx interface requesting PDN-GW 230 to provision a new policy and control charging (PCC) rule for UE 201. For example, MSG 51 is a Re-Auth-Request (RAR) message.

PDN-GW 230, in response to receiving the request to provision a new PCC rule for UE 201 (i.e., MSG 1), determines that UE 201 is congested based on information stored in a local data structure. Responsive to determining that UE 201 is congested, PDN-GW 230 rejects the request from PCRF 250 to provision a new PCC rule for UE 201 by sending MSG 58 back to PCRF 250. PCRF 250, in turn, denies Service Provider 260 the opportunity to deliver data (e.g., the HD video streaming session) to UE 201.

In rejecting the request to create a new PCC rule, PDN-GW 230 discards MSG 51 by suppressing bearer creation/modification requests to SGW 220. By way of example, PDN-GW 230 does not send bearer creation/modification MSG 52, which a conventional PDN-GW would send. By not sending MSG 52, PDN-GW 230 also prevents MSG 53 through MSG 57 from being exchanged in EPS 200. In contrast, MSG 53 through MSG 57 would be exchanged in a conventional EPS. It is clear, therefore, that the mechanisms provided by eNodeB 211 and PDN-GW 230 reduce the number of messages being exchanged in EPS 200. It is worth noting that the advantages of the present invention are further magnified as the duration of the radio network congestion extends longer and longer. For instance, by sending only one set of MSG 48 through MSG 50, eNodeB 211 and PDN-GW 230 are able to prevent many sets of MSG 52 through 57 from being exchanged in EPS 200 because multiple requests for provisioning of a new PCC rule may occur while UE 201 remains in the congested state.

In one embodiment, when eNodeB 211 determines that UE 201 has changed congestion status from congested to not congested, eNodeB 211 sends MSG 59 to SGW 220 indicating UE 201 is not congested. MSG 59 is propagated to PDN-GW 230 as MSG 61.

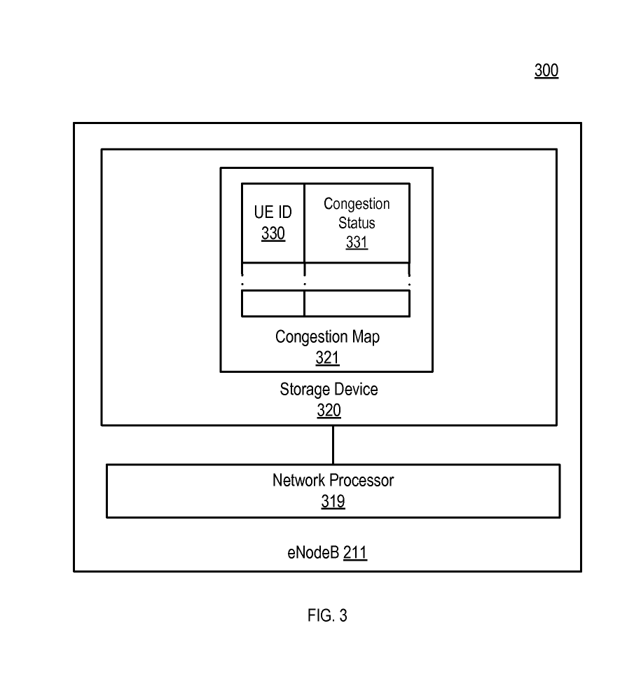

FIG. 3 is a block diagram illustrating an embodiment of eNodeB 211. eNodeB 211 includes a network processor, e.g., network processor 319, for processing radio load condition. In one embodiment, network processor 319 is configured to estimate congestion at a UE granularity level. As used herein, “UE granularity level” means that the congestion is determined on a per UE basis, not on a per small cell (i.e., eNodeB basis). By determining congestion at a UE granularity, eNodeB 211 avoids indiscriminately preventing all UEs in the same small cell (i.e., all UEs communicatively coupled to the same eNodeB) from being able to establish new bearers because one UE is determined to be congested. By way of example, as illustrated in FIG. 2, UE 201 is congested, while UE 202 is not congested. By sending congestion status at a UE granularity level to PDN-GW 230, eNodeB 211 enables PDN-GW 230 to request bearer creation/modification for UE 201 while suppressing requests for provisioning of new PCC rules for UE 202.

In one embodiment, eNodeB 211 determines congestion at a UE granularity level by monitoring and averaging parameters such as total transmitted power to each UE. Alternatively, or in addition to, eNodeB 211 is configured to determine congestion by monitoring the interference associated with signals received from each UE. By way of example, as illustrated in FIG. 2, UE 201 is located further away from eNodeB 211 than UE 202 is located from eNodeB 211. This may cause both UE 201 and eNodeB 211 to exchange messages at a higher transmit power because they are far from each other. These messages may suffer from high interference because the two devices are located far from each other. In one embodiment, eNodeB 211 may use this type of information to determine that UE 201 is congested. Since UE 202 is located closer to eNodeB 211, they may exchange messages at a lower transmit power, and these messages may suffer interference at a low level. eNodeB 211, in one embodiment, may use this information to determine that UE 202 is not congested.

The mechanisms for determining congestion discussed above are only for illustrative purposes, and not intended to be a limitation of the present invention. For example, in some embodiments, congestion may be monitored at each UE which then reports to eNodeB 211, which in turn forwards to PDN-GW 230.

In one embodiment, congestion status of each UE (e.g., UE 201-202) communicatively coupled to eNodeB 211 is maintained in congestion map 321, which is stored in storage device 320. In one embodiment, congestion map 321 includes UE identifier (ID) portion 330 and a corresponding congestion status portion 331. The UE ID portion 330 contains one or more IDs of UEs that have been determined to be either congested or not congested by network processor 319. Each UE ID stored in UE ID portion 330 has a corresponding congestion status stored in congestion status portion 331. Although UE ID portion 330 is logically associated with congestion status portion 331, one skilled in the art will recognize that UE ID portion 330 and congestion status portion 331 need not necessarily be stored in contiguous storage areas of storage device 320, nor even reside in the same storage device. In one embodiment, the UE ID may be the International Mobile Subscriber Identity (IMSI) of the UE. Alternatively, the UE ID may be some other logical address of the UE, e.g., the IP address of the UE.

In one embodiment, network processor 319 is configured to forward/send the congestion status of each UE to PDN-GW 230. In one embodiment, network processor 319 sends UE congestion status in-band, i.e., over the user plane. A user plane exists between the eNodeBs and the SGW through the S1 U interface; a user plane exists between the SGW and the PDN-GW over the S5 interface. In an alternate embodiment, network processor 319 sends the UE congestion status out-band to MME 240, i.e., over the control plane. A control plane exists between the eNodeBs and the MME over the S1C-MME interface.

According to one embodiment where UE congestion status is sent to PDN-GW 230 in-band, network processor 319 is configured to generate an Internet Protocol (IP) packet containing the UE congestion status as part of the IP packet payload (e.g., MSG 48). In such an embodiment, the IP packet header information (e.g., source/destination IP address, source/destination port, and protocol type) is copied from an IP packet previously sent from the UE (for which the status is being reported) to PDN-GW 230. In one embodiment, network processor 319 creates and sends an IP packet (e.g., MSG 48) containing the UE congestion status for each bearer that the UE has been provisioned. By sending a congestion status IP packet for each bearer belonging to the UE, network processor 319 ensures that each PDN-GW in which the UE has a PDN-Connection receives the congestion status. For instance, in the case where a congested UE has multiple bearers, each bearer is with a different PDN-GW, by sending a congestion status IP packet for each bearer, network processor 319 guarantees that all PDN-GWs will be informed of the UE's congestion status. It should be noted that these special IP packets are discarded, i.e., prevented from being forwarded beyond the EPS.

According to another embodiment where UE congestion status is sent to PDN-GW 230 in-band, network processor 319 is configured to generate a GPRS Tunneling Protocol (GTP) packet (e.g., MSG 48) containing the UE congestion status and send the GTP packet to PDN-GW 230. In such an embodiment, the congestion status is included as part of a proprietary extension header of the generated GTP header, where bits 7 and 8 in the Next Extension Header Type are both set to 0. By setting both bits 7 and 8 to 0, network processor 319 ensures that SGW 220 will not attempt to interpret the extension header. By setting both bits 7 and 8 to 0, network processor 319 informs SGW 220 to preserve the contents of the GTP header and simply forward the GTP packet to PDN-GW 230 (which will extract the congestion status from the GTP header).

According to an embodiment where UE congestion status is sent out-band to PDN-GW 230, network processor 319 is configured to generate GTP packets to PDN-GW 230. In such an embodiment, an extension of the 3GPP protocol may be required, e.g., to enable eNodeBs discovery of the PDN-GW(s) in which the UE is anchored, based, e.g., on an extension of the S1-C MME interface. In one embodiment, network processor 319 is configured to send a congestion status for a UE whenever the UE changes congestion state, e.g., from congested to not congested, and vice versa. In one embodiment, normalization is applied by network processor 319 to avoid sending congestion status messages too frequently.

The above description describes congestion monitoring and reporting being performed by a network processor. It will be appreciated, however, that the mechanisms may be implemented in hardware or a combination of hardware and software. Congestion monitoring and reporting mechanisms have been discussed with respect to eNodeB 211. It will be appreciated, however, that these mechanisms are not limited to any particular eNodeB in an EPS. The congestion monitoring and reporting mechanisms discussed herein are equally applicable to any eNodeB in EPS 200.

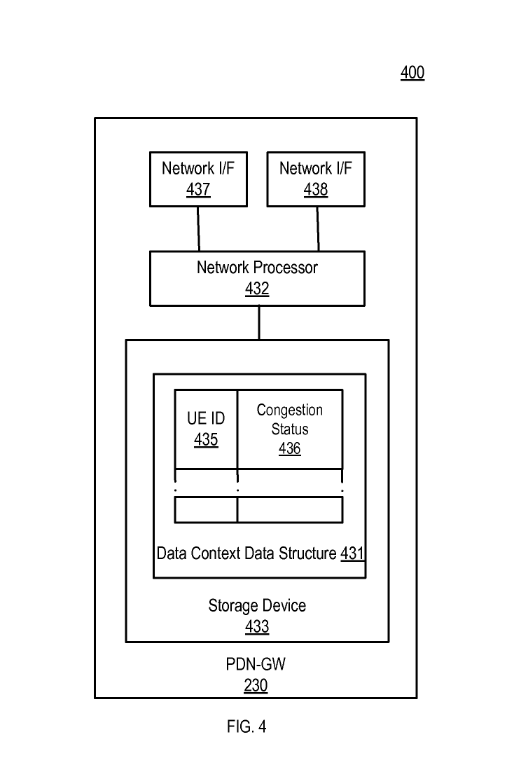

FIG. 4 is a block diagram illustrating an embodiment of PDN-GW 230. PDN-GW 230 includes network interfaces (I/Fs) 437-438 to exchange messages in EPS 200. For example, network I/F 437 is configured to interface with the S5 interface for receiving data in-band. In an embodiment where congestion status messages are sent in-band, PDN-GW 230 is configured to receive the congestion status messages via network I/F 437. Network I/F 438 is configured to interface with the Gx interface. For example, requests to create new PCC rules from PCRF 250 are received by PDN-GW 230 via network I/F 438.

In one embodiment, PDN-GW 230 is further configured to include a network processor, such as network processor 432. Network Processor 432 is configured to process received congestion status messages from eNodeB 211 via network I/F 437 and maintain data context data structure 431 based on information of the received congestion status messages. Data context data structure 431 is stored as part of storage device 433.

In one embodiment, data context data structure 431 includes UE identifier (ID) portion 435 and a corresponding congestion status portion 436. The UE ID portion 435 contains one or more IDs of UEs for which a congestion status message has been received by PDN-GW 230. Each UE ID stored in UE ID portion 435 has a corresponding congestion status stored in congestion status portion 436. The congestion status is copied from the congestion status that was received most recently for the UE identified by the corresponding UE ID in UE ID portion 435. Although UE ID portion 435 is logically associated with congestion status portion 436, one skilled in the art will recognize that UE ID portion 435 and congestion status portion 436 need not necessarily be stored in contiguous storage areas of storage device 433, nor even reside in the same storage device. In one embodiment, the UE ID may be the International Mobile Subscriber Identity (IMSI) of the UE. Alternatively, the UE ID may be some other logical address of the UE, e.g., the IP address of the UE. In some embodiments, network processor 432 is configured to translate between IMSIs and IP addresses of the UEs.

In one embodiment, network processor 432 is configured to process requests from PCRF 250 to provision new PCC rules via network I/F 438. In one embodiment, in response to receiving the request from PCRF 250, network processor 432 determines if the UE for which the request is made is congested. In such an embodiment, network processor 432 determines if the UE ID identifying the UE for which a new PCC rule is being requested exists in data context data structure 431. If the UE ID does not exist in data structure 431, network processor 432 determines that the UE is not congested. If network processor 432 determines that the UE ID identifying the UE for which a new PCC rule is being requested exists in data structure 431 but the corresponding status bit in the data structure indicates the UE is not congested, network processor 432 also determines that the UE is not congested. In one embodiment, when network processor 432 determines the UE ID identifying the UE for which a request to provision a new PCC rule exists in data structure 431, and the corresponding congestion status bit in the data structure indicates the UE is congested, network processor 432 determines that the UE is congested.

In one embodiment, when network processor 432 determines that the UE for which the request to provision a new PCC rule is made is not congested, network processor 432 initiates a bearer creation/modification for the UE, e.g., by sending a message similar to MSG 2 of FIG. 1. When network processor 432 sends a request to create/modify a bearer for the UE determined to be not congested based on information of data structure 431, eNodeB 211 will likely grant the request and allow a new bearer to be setup. In contrast, the likelihood of a conventional eNodeB granting the new bearer creation/modification is unpredictable because when a conventional PDN-GW initiates a bearer creation/modification, it has no knowledge whether the UE for which the bearer is being requested is congested or not congested. In a conventional EPS, if the UE turns out to be congested, a series of messages would be exchanged resulting in a denial of a new PCC rule.

In one embodiment, when network processor 432 determines that the UE for which the request to provision a new PCC rule is made is congested, network processor 432 rejects the request by sending a message (e.g., MSG 58) back to PCRF 250. In such an embodiment, network processor 432 discards the request from PCRF 250 at PDN-GW 230 by suppressing bearer creation/modification messages. In other words, network processor 432 prevents MSG 52 through MSG 57 from being exchanged in EPS 200. Again, this is in contrast to a conventional PDN-GW which does not have knowledge of UE congestion, and would blindly send bearer creation/modification messages to the corresponding eNodeB, and receive in return, messages denying the request to create/modify the bearer for the congested UE (e.g., MSG 2 through MSG 7).

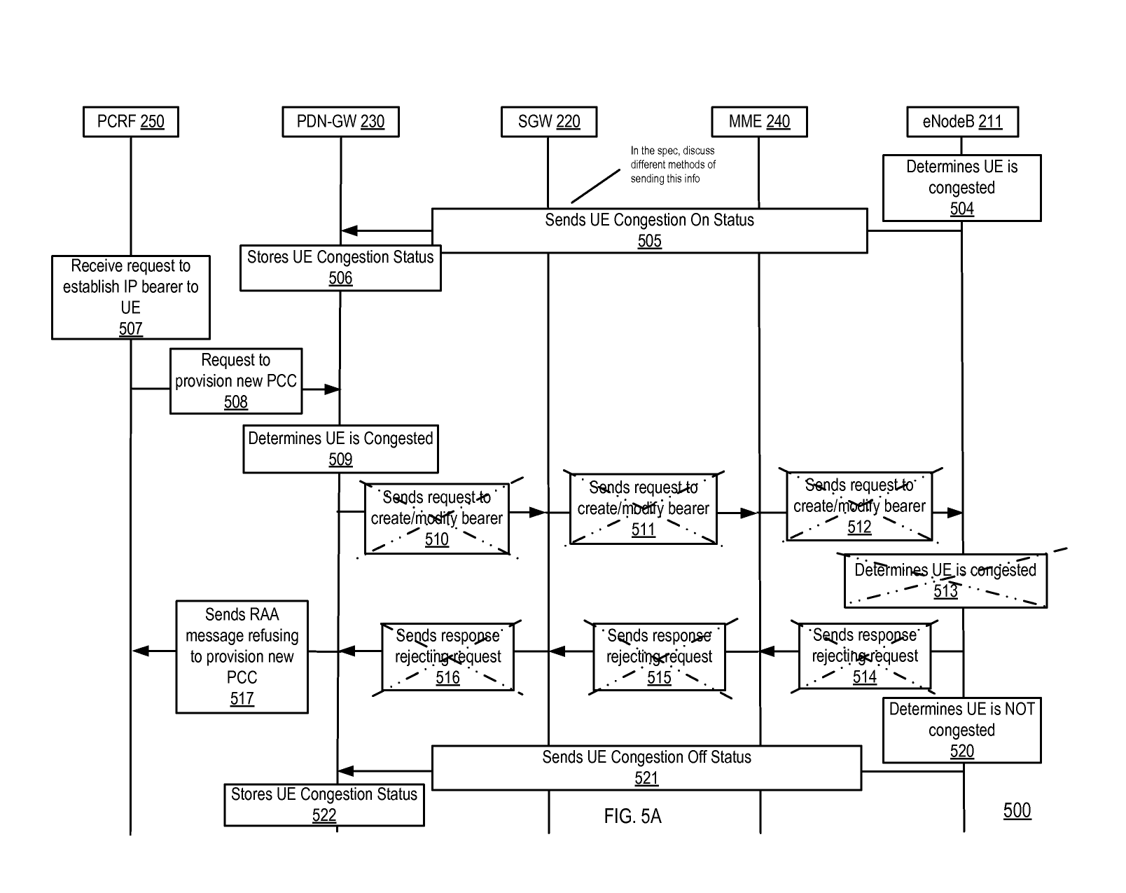

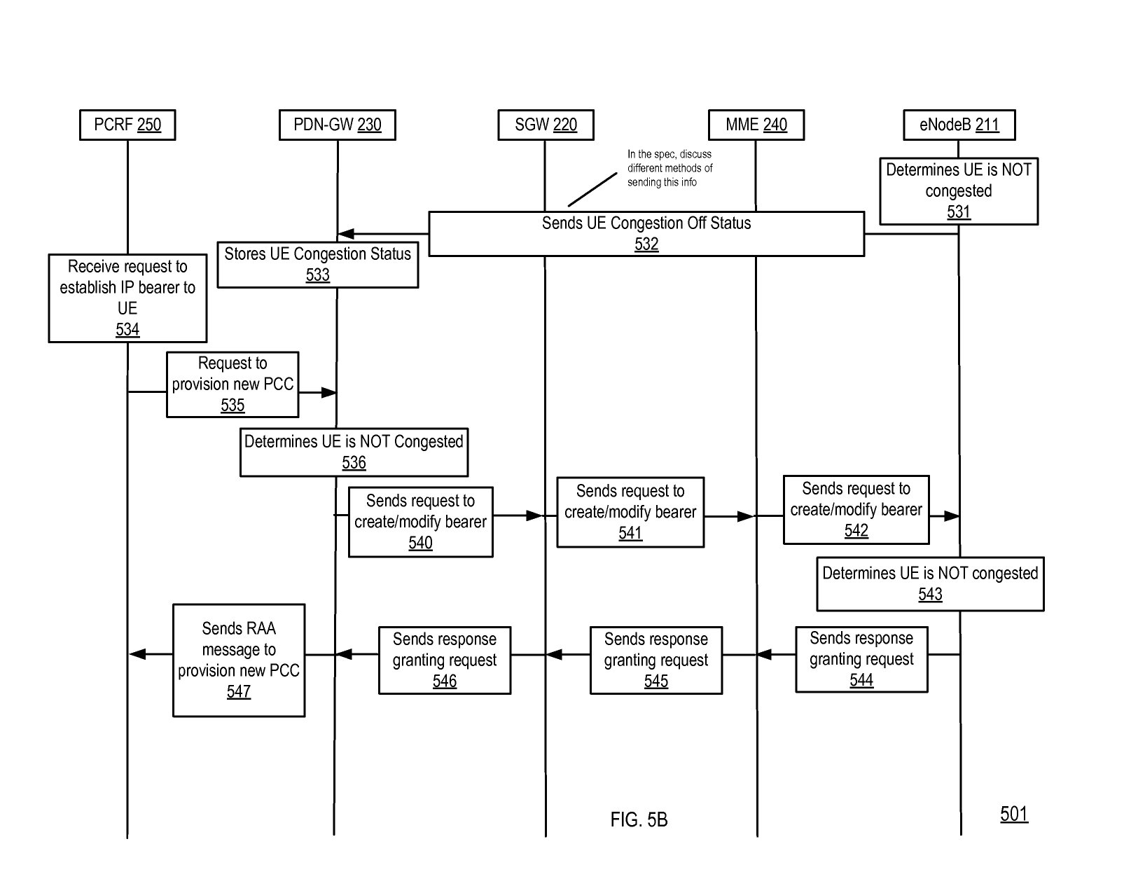

FIG. 5A is a flow diagram illustrating a method 500 for reducing the number of bearer creation/modification messages in EPS 200. The operations of this and other flow diagrams will be described with reference to the exemplary embodiments of the other diagrams. It should be understood, however, that the operations of the flow diagrams can be performed by embodiments of the invention other than those discussed with reference to these other diagrams, and the embodiments of the invention discussed with reference these other diagrams can perform operations different than those discussed with reference to the flow diagrams.

In FIG. 5A, an “X” mark over a transaction denotes that the transaction is one that would typically be performed in a conventional EPS, but which is efficiently skipped by EPS 200 of the present invention. Referring now to FIG. 5A, at operation 504, eNodeB 211 determines that UE 201 is congested. Responsive to this determination, at transaction 505, eNodeB 211 sends UE congestion ON status messages (e.g., MSG 48 and MSG 50) destined for PDN-GW 230. At operation 506, PDN-GW 230 stores the UE congestion status contained in the congestion ON status message. For example, network processor 432 stores the ID of UE 201 in UE ID portion 435 of data context data structure 431. Network processor 432 also marks the UE as congested by setting the corresponding congestion status portion 436 to a value indicating UE 201 is congested.

At operation 507, PCRF 250 receives a request to establish an IP bearer to UE 201. At transaction 508, PCRF 250 sends to PDN-GW 230 a request (e.g., MSG 51) to provision a new PCC rule for UE 201. During operation 509, PDN-GW 230 determines that UE 201 is congested. For example, network processor 432 determines that the ID of UE 201 exists in the UE ID portion 435 of data structure 431, and the corresponding congestion status portion 436 in data structure 431 indicates UE 201 is congested.

At transaction 517, PDN-GW 230 sends a response message (e.g., MSG 58) back to PCRF 250 refusing to create a new PCC rule for UE 201. By having knowledge of the fact that UE 201 is congested, PDN-GW 230 is able to skip transaction 510, which in turn prevents transactions 511 through 516 from being performed. By preventing these transactions from being performed, the present invention reduces the processing resources that would otherwise be required in the various network devices of the EPS. Furthermore, by not having to perform these transactions, messages are also reduced in EPS 200. For instance, the suppression of transactions 510 through 516 prevents MSG 52 through MSG 57 from being exchanged in EPS 200.

At transaction 520, eNodeB 211 determines that UE 201 is no longer congested. During transaction 521, eNodeB 211 send a congestion OFF message (e.g., MSG 59) to SGW 220, which propagates to PDN-GW 230 as MSG 61. At operation 522, PDN-GW 230 stores the UE congestion status received. For example, network processor 432 looks up UE ID portion 435 to find the ID identifying UE 201 and sets the corresponding congestion status portion 436 to a value indicating UE 201 is not congested.

FIG. 5B is a flow diagram illustrating a method 501 requesting for bearer creation/modification will a high likelihood of the bearer being created. The operations of this and other flow diagrams will be described with reference to the exemplary embodiments of the other diagrams. It should be understood, however, that the operations of the flow diagrams can be performed by embodiments of the invention other than those discussed with reference to these other diagrams, and the embodiments of the invention discussed with reference these other diagrams can perform operations different than those discussed with reference to the flow diagrams.

Referring now to FIG. 5B, at transaction 531, eNodeB 211 determines that UE 201 is not congested. During transaction 532, eNodeB 211 send a congestion OFF message (e.g., MSG 59) to SGW 220, which propagates to PDN-GW 230 as MSG 61. At operation 533, PDN-GW 230 stores the UE congestion status received. For example, network processor 432 looks up UE ID portion 435 to find the ID identifying UE 201 and sets the corresponding congestion status portion 436 to a value indicating UE 201 is not congested. If the ID of UE 201 does not exist in data structure 431, network processor 432 inserts a new UE ID portion 435 and new congestion status portion 436 in the data structure and marks the congestion status in the new congestion status portion 436 to indicate UE 201 is not congested.

At operation 534, PCRF 250 receives a request to establish an IP bearer to UE 201. At transaction 535, PCRF 250 sends to PDN-GW 230 a request (e.g., MSG 51) to provision a new PCC rule for UE 201. During operation 536, PDN-GW 230 determines that UE 201 is not congested. For example, network processor 432 determines that the ID of UE 201 exists in the UE ID portion 435 of data structure 431, and the corresponding congestion status portion 436 in data structure 431 indicates UE 201 is not congested.

At transaction 540, PDN-GW 230 sends a request to create or modify a bearer for UE 201. At transaction 541, SGW 230 forwards to the request to MME 240, which forwards it to eNodeB 211 at transaction 542. During operation 543, eNodeB 211 determines that UE 201 is not congested (e.g., UE 201 has come closer to eNodeB 211). At transaction 544, eNodeB 211 sends a response to MME 240 granting the request to create/modify a bearer for UE 201. At transaction 545, MME 240 forwards to grant to SGW 220, which forwards the grant to PDN-GW 230 at transaction 546. At transaction 547, PDN-GW 230 sends a message back to PCRF 250 granting the request to provision a new PCC for UE 201.

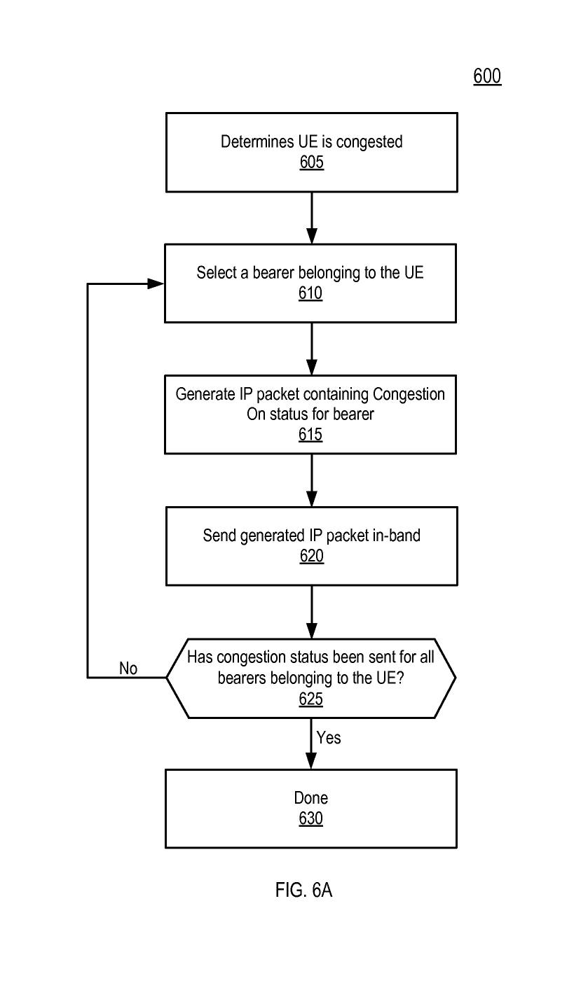

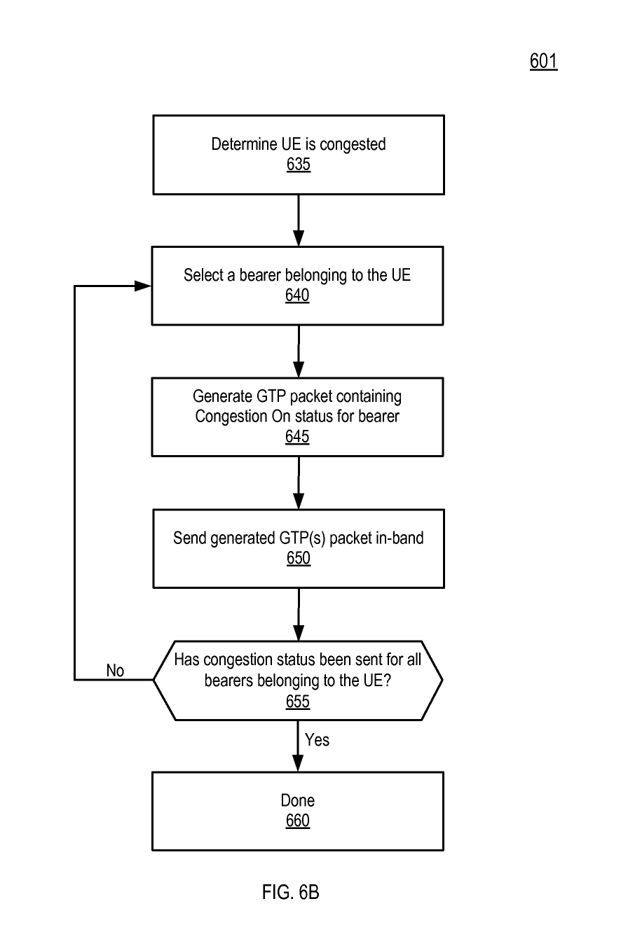

FIG. 6A is a flow diagram illustrating method 600 for sending congestion status to a PDN-GW, according to one embodiment. For example, method 600 may be performed by network processor 319 of eNodeB 211. Referring now to FIG. 6A, at block 605, network processor 319 determines a UE (e.g., UE 201) is congested using mechanisms similar to those discussed above.

At block 610, network processor 319 selects a bearer belonging to the UE. At block 615, network processor 319 generates an IP packet containing congestion ON status for the selected bearer. For example, the congestion status may be stored as part of the IP packet payload. At block 620, network processor 319 sends the generated IP packet in-band destined for a PDN-GW, such as PDN-GW 230. The IP packet may be sent, for example, as MSG 48.

At block 625, network processor 319 determines if a congestion status message has been sent for all bearers belong to the UE. If a congestion status message has been sent for all bearers belonging to the UE, method 600 is completed at block 630. If at least one bearer belonging to the UE has not been sent a congestion status message, method 600 loops back to block 610 and selects another bearer for processing.

Although method 600 is described as being performed by a network processor, it will be understood that method 600 is not so limited and may be performed by hardware or a combination of hardware and software.

FIG. 6B is a flow diagram illustrating method 601 for sending congestion status to a PDN-GW, according to one embodiment. For example, method 601 may be performed by network processor 319 of eNodeB 211. Referring now to FIG. 6B, at block 635, network processor 319 determines a UE (e.g., UE 201) is congested using mechanisms similar to those discussed above.

At block, 640, network processor 319 selects a bearer belonging to the UE. At block 645, network processor 319 generates an GTP packet containing congestion ON status for the selected bearer. For example, the congestion status may be stored as part of the GTP packet header as discussed above. At block 650, network processor 319 sends the generated GTP packet in-band destined for a PDN-GW, such as PDN-GW 230. The GTP packet may be sent, for example, as MSG 48.

At block 655, network processor 319 determines if a congestion status message has been sent for all bearers belong to the UE. If a congestion status message has been sent for all bearers belonging to the UE, method 601 is completed at block 660. If at least one bearer belonging to the UE has not been sent a congestion status message, method 601 loops back to block 640 and selects another bearer for processing.

Although method 601 is described as being performed by a network processor, it will be understood that method 601 is not so limited and may be performed by hardware or a combination of hardware and software.

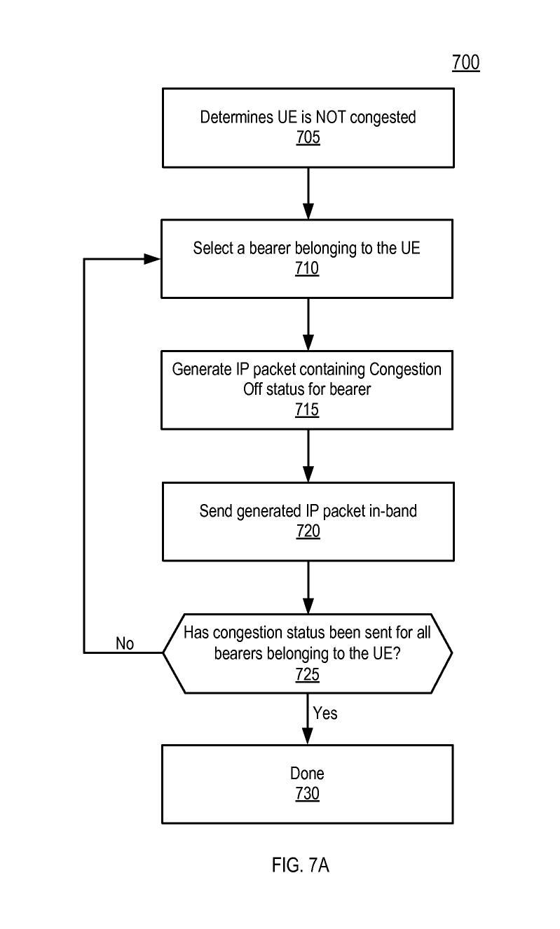

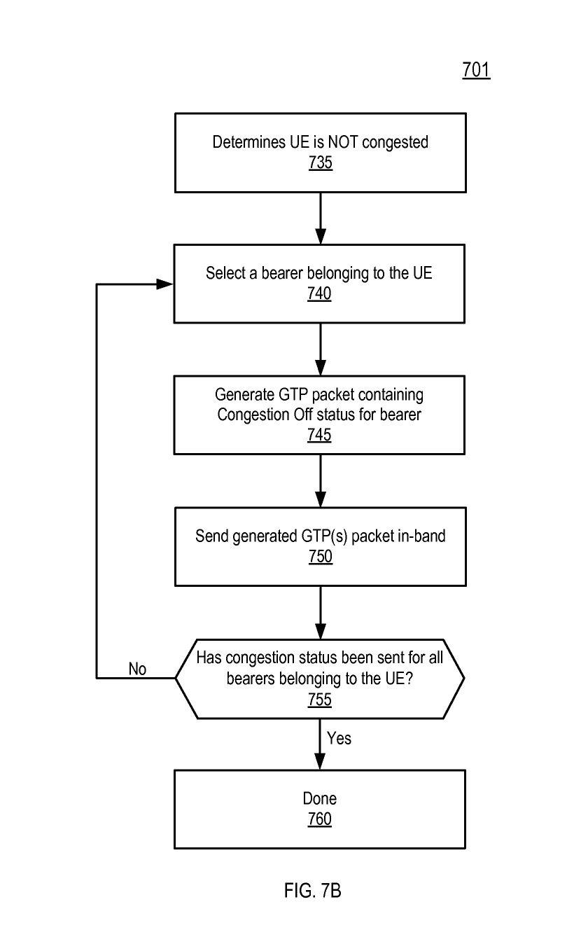

FIG. 7A is a flow diagram illustrating method 700 for sending congestion status to a PDN-GW, according to one embodiment. For example, method 700 may be performed by network processor 319 of eNodeB 211. Referring now to FIG. 7A, at block 705, network processor 319 determines a UE (e.g., UE 201) is not congested using mechanisms similar to those discussed above.

At block 710, network processor 319 selects a bearer belonging to the UE. At block 715, network processor 319 generates an IP packet containing congestion OFF status for the selected bearer. For example, the congestion status may be stored as part of the IP packet payload. At block 720, network processor 319 sends the generated IP packet in-band destined for a PDN-GW, such as PDN-GW 230. The IP packet may be sent, for example, as MSG 59.

At block 725, network processor 319 determines if a congestion status message has been sent for all bearers belong to the UE. If a congestion status message has been sent for all bearers belonging to the UE, method 700 is completed at block 730. If at least one bearer belonging to the UE has not been sent a congestion status message, method 700 loops back to block 710 and selects another bearer for processing.

Although method 700 is described as being performed by a network processor, it will be understood that method 700 is not so limited and may be performed by hardware or a combination of hardware and software.

FIG. 7B is a flow diagram illustrating method 701 for sending congestion status to a PDN-GW, according to one embodiment. For example, method 701 may be performed by network processor 319 of eNodeB 211. Referring now to FIG. 7B, at block 735, network processor 319 determines a UE (e.g., UE 201) is not congested using mechanisms similar to those discussed above.

At block, 740, network processor 319 selects a bearer belonging to the UE. At block 745, network processor 319 generates an GTP packet containing congestion OFF status for the selected bearer. For example, the congestion status may be stored as part of the GTP packet header as discussed above. At block 750, network processor 319 sends the generated GTP packet in-band destined for a PDN-GW, such as PDN-GW 230. The GTP packet may be sent, for example, as MSG 59.

At block 755, network processor 319 determines if a congestion status message has been sent for all bearers belong to the UE. If a congestion status message has been sent for all bearers belonging to the UE, method 701 is completed at block 760. If at least one bearer belonging to the UE has not been sent a congestion status message, method 701 loops back to block 740 and selects another bearer for processing.

Although method 701 is described as being performed by a network processor, it will be understood that method 601 is not so limited and may be performed by hardware or a combination of hardware and software.

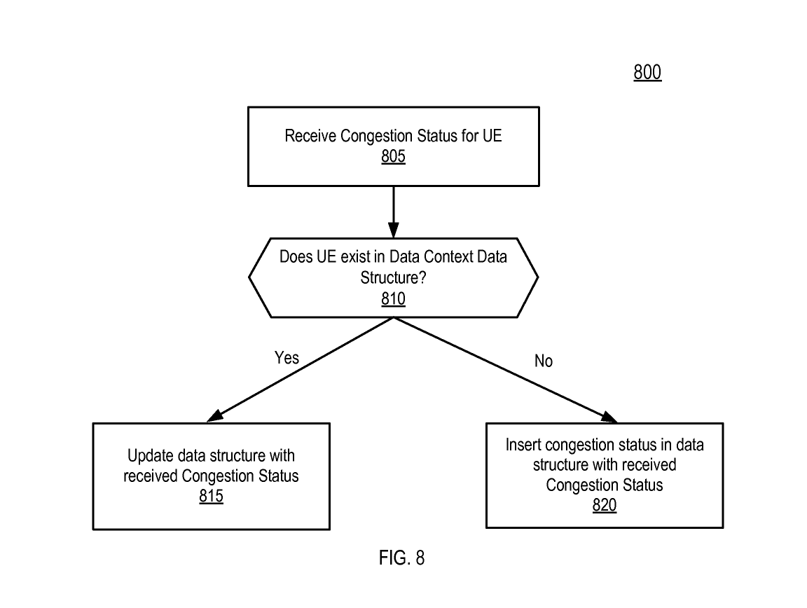

FIG. 8 is a flow diagram illustrating method 800 for maintaining UE congestion status at PDN-GW 230, according to one embodiment. For example, method 800 may be performed by network processor 432 of PDN-GW 230. Referring now to FIG. 8, at block 805, network processor 432 receives a congestion status message (e.g., MSG 50 or MSG 61), via network port 437.

At block 810, network processor 432 determines if a congestion status for the UE exists in data structure 431. At block 815, in response to determining that a congestion status for the UE already exists in data structure 431, network processor 432 updates the data structure to indicate the UE is either congested or not congested, based on information of the received congestion status message.

At block 820, in response to determining that a congestion status for the UE does not exist in data structure 431, network processor 432 inserts a new congestion status in the data structure indicating the UE is either congested or not congested, based on information of the received congestion status message. For example, network processor 432 creates a new UE ID portion 435 and corresponding congestion status portion 436. The network processor 432 populates the new UE ID portion 435 with the ID identifying the UE, and populates the new congestion status portion 4436 with either a value indicating the UE is congested or a value indicating the UE is not congested, based on information of the received congestion status message.

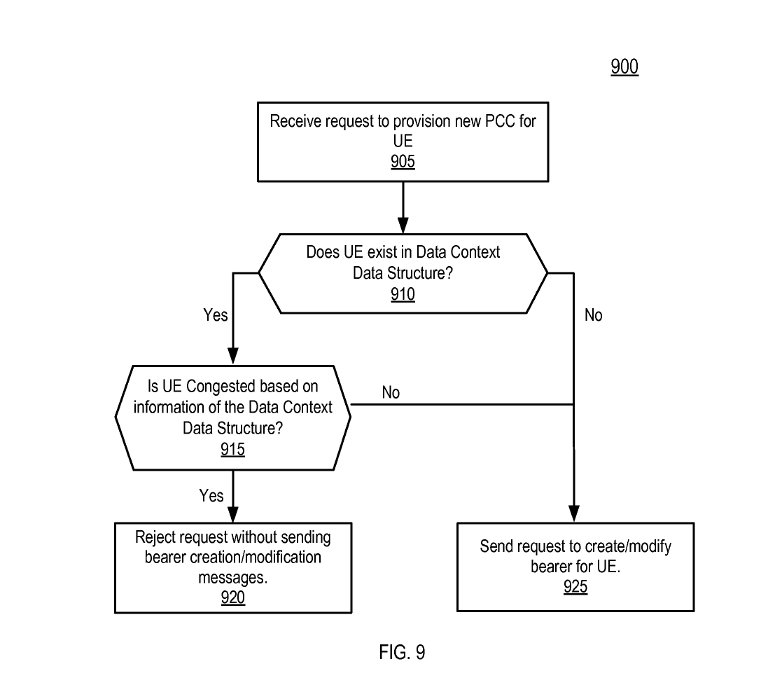

FIG. 9 is a flow diagram illustrating method 900 for reducing the number of messages being exchanged in an EPS such as EPS 200, according to one embodiment. For example, method 900 may be performed by network processor 432 of PDN-GW 230. Referring now to FIG. 9, at block 905, network processor 432 receives a request (e.g., MSG 51) to provision a new PCC rule for a UE (e.g., UE 201).

At block 910, network processor 432 determines whether the congestion status for the UE exists in data structure 431. For example, network processor 432 determines whether an ID identifying the UE exists in UE ID portion 435 of data structure 431. At block 915, in response to determining the congestion status for the UE does exist in data structure 431, network processor 432 determines whether the UE is congested based on information of data structure 431. For example, network processor 432 determines whether congestion status portion 436 (corresponding to UE ID portion 435 containing the ID of the UE) contains a value indicating the UE is congested.

At block 920, in response to determining the UE is congested based on information of data structure 431, network processor 432 rejects the request to provision a new PCC rule for the UE without sending any bearer creation/modification messages. For example, network processor 432 does not send MSG 52, thus preventing MSG 53 through MSG 57 from being exchanged in EPS 200. At block 925, in response to determining that a congestion status for the UE does not exist in data structure 431, network processor 432 sends a request to create/modify a bearer for the UE.

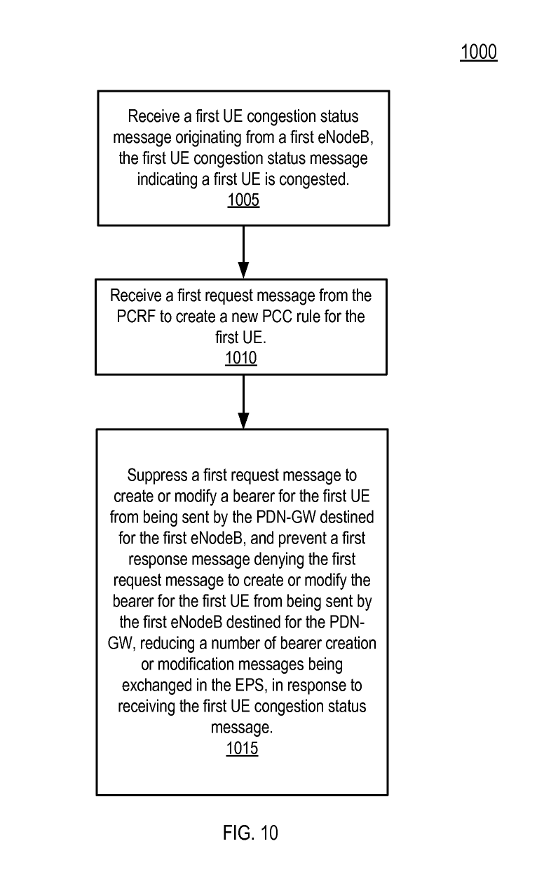

FIG. 10 is flow diagram illustrating method 1000 for reducing the number of messages from being exchanged in an EPS, such as EPS 200, according to one embodiment. For example, method 1000 may be performed by network processor 432. Referring now to FIG. 10, at block 1005, network processor 432 receives a first UE congestion status message (e.g., MSG 50) originating from a first eNodeB (e.g., eNodeB 211) of the plurality of eNodeBs (e.g., eNodeBs 211-212), the first UE congestion status message (MSG 50) indicating a first UE (e.g., UE 201) of the plurality of UEs (201-202) is congested.

At block 1010, network processor 432 receives a first request message (e.g., MSG 51) from the PCRF (e.g., PCRF 250) to create a new policy and charging control (PCC) rule for the first UE (201).

At block 1015, network processor 432 discards the first request message (e.g., MSG 51) at PDN-GW 230 to prevent a first request message (e.g., MSG 52) to create or modify a bearer for the first UE (e.g., UE 201) from being sent by PDN-GW 230 destined for the first eNodeB, and prevent a first response message (e.g., MSG 55) denying the first request message to create or modify the bearer for the first UE from being sent by the first eNodeB destined for PDN-GW 230, reducing a number of bearer creation or modification messages being exchanged in the EPS, in response to receiving the first UE congestion status message.

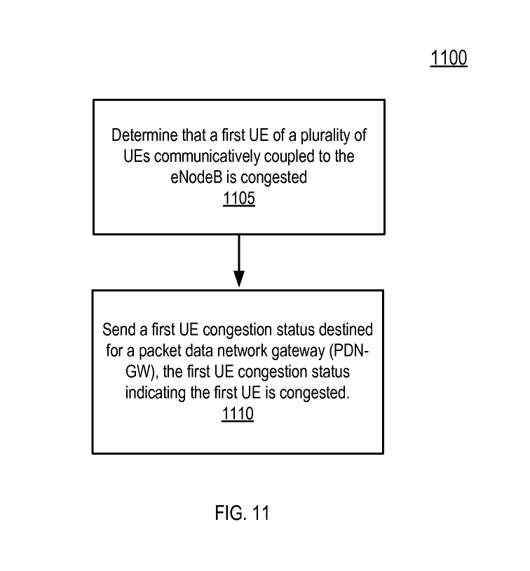

FIG. 11 is a flow diagram illustrating method 1100 for sending UE congestion status, according to one embodiment. For example, method 1100 may be performed by network processor 319. Referring now to FIG. 11, at block 1105, network processor 319 determines that a first UE of a plurality of UEs communicatively coupled to an eNodeB is congested. At block 1110, network processor 319 sends a first UE congestion status message destined for a PDN-GW, the first UE congestion status indicating the first UE is congested.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable medium. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical or other form of propagated signals (e.g., carrier waves, infrared signals, digital signals, etc.)), etc.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of operations and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

What is claimed is:

1. A method in a packet data network gateway (PDN-GW) of a 3rd Generation Partnership Project (3GPP) Evolved Packet System (EPS), the EPS comprising a plurality of user equipments (UEs) communicatively coupled to a plurality of Evolved Node Bs (eNodeBs), the plurality of Evolved Node Bs (eNodeBs) communicatively coupled to the PDN-GW, the PDN-GW communicatively coupled to a policy and charging rules function (PCRF), for reducing bearer creation or modification messages being exchanged in the EPS, the method comprising:
receiving a first UE congestion status message originating from a first eNodeB of the plurality of eNodeBs, the first UE congestion status message indicating a first UE of the plurality of UEs is congested;
receiving a first request message from the PCRF to create a new policy and charging control (PCC) rule for the first UE;
suppressing a first request message to create or modify a bearer for the first UE from being sent by the PDN-GW destined for the first eNodeB, and prevent a first response message denying the first request message to create or modify the bearer for the first UE from being sent by the first eNodeB destined for the PDN-GW, reducing a number of bearer creation or modification messages being exchanged in the EPS, in response to receiving the first UE congestion status message.

2. The method of claim 1, further comprising updating a data context data structure located at the PDN-GW to indicate the first UE is congested, in response to receiving the first UE congestion status message.

3. The method of claim 2, wherein discarding the first request message further comprising determining that an Internet Protocol (IP) address of the first UE exists in the data context data structure, and a corresponding congestion status bit in the data context data structure contains a bit value indicating the first UE is congested.

4. The method of claim 1, further comprising:
receiving a second UE congestion status message originating from the first eNodeB, the second UE congestion status message indicating the first UE is not congested;
receiving a second request message from the PCRF to create a new PCC rule for the first UE;
transmitting a second request message to create or modify a bearer for the first UE destined for the first eNodeB, in response to receiving the second UE congestion status message.

5. The method of claim 4, further comprising updating a data context data structure located at the PDN-GW to indicate the first UE is not congested, in response to receiving the second UE congestion status message.

6. The method of claim 5, wherein transmitting the second request message to create or modify the bearer for the first UE destined for the first eNodeB further comprising determining that an Internet Protocol (IP) address of the first UE exists in the data context data structure, and a corresponding congestion status bit in the data context data structure contains a bit value indicating the first UE is not congested.

7. The method of claim 5, wherein transmitting the second request message to create or modify the bearer for the first UE destined for the first eNodeB further comprising determining that an Internet Protocol (IP) address of the first UE does not exist in the data context data structure.

8. A packet data network gateway (PDN-GW) of a 3rd Generation Partnership Project (3GPP) Evolved Packet System (EPS), the EPS comprising a plurality of user equipments (UEs) communicatively coupled to a plurality of Evolved Node Bs (eNodeBs), the plurality of Evolved Node Bs (eNodeBs) communicatively coupled to the PDN-GW, the PDN-GW communicatively coupled to a policy and charging rules function (PCRF), for reducing bearer creation or modification messages being exchanged in the EPS, the PDN-GW comprising:
a first network interface configured to receive a plurality of congestion status messages from the plurality of eNodeBs, each congestion status message indicating whether a corresponding UE for which the message was sent is congested;
a second network interface configured to receive a plurality of request messages from the PCRF to create a new policy and charging control (PCC) rule for a corresponding UE for which the request message was sent;
a network processor configured, for each received request message from the PCRF to create a new PCC rule for a corresponding UE, to suppress request messages to create or modify bearers from being sent by the PDN-GW destined for an eNodeB communicatively coupled to the corresponding UE, and prevent response messages denying the request messages to create or modify bearers from being sent by the eNodeB communicatively coupled to the corresponding UE destined for the PDN-GW, reducing a number of bearer creation or modification messages being exchanged in the EPS, in response to receiving one or more UE congestion status messages indicating the corresponding UE is congested.

9. The PDN-GW of claim 8, further comprising:
a storage device configured to store a data context data structure,
the data context data structure containing information indicating whether one or more UEs are congested; and
the network processor is further configured to update the data context data structure to indicate the corresponding UE is congested, in response to receiving one or more UE congestion status messages indicating the corresponding UE is congested.

10. The PDN-GW of claim 9, wherein the network processor is further configured to determine that the corresponding UE is congested by determining that an Internet Protocol (IP) address of the corresponding UE exists in the data context data structure, and a corresponding congestion status bit in the data context data structure contains a bit value indicating the corresponding UE is congested.

11. The PDN-GW of claim 8, wherein the network processor is further configured, for each received request message from the PCRF to create a new PCC rule for the corresponding UE, to cause the PDNG-GW to transmit a request message to create or modify bearer destined for the eNodeB communicatively coupled to the corresponding UE, in response to receiving one or more UE congestion status messages indicating the corresponding UE is not congested.

12. The PDN-GW of claim 9, wherein the network processor is further configured to update a data context data structure located at the PDN-GW to indicate the corresponding UE is not congested, in response to receiving one or more UE congestion status messages indicating the corresponding UE is not congested.

13. The PDN-GW of claim 12, wherein the network processor is configured to determine that the corresponding UE is not congested by determining that an Internet Protocol (IP) address of the corresponding UE exists in the data context data structure, and a corresponding congestion status bit in the data context data structure contains a bit value indicating the corresponding UE is not congested.

14. The PDN-GW of claim 13, wherein the network processor is configured to determine that the corresponding UE is not congested by determining that an Internet Protocol (IP) address of the corresponding UE does not exist in the data context data structure.

15. A method in an Evolved Node B (eNodeB) of a 3rd Generation Partnership Project (3GPP) Evolved Packet System (EPS), the EPS comprising a plurality of user equipments (UEs) communicatively coupled to a plurality of Evolved Node Bs (eNodeBs), the plurality of eNodeBs communicatively coupled to a packet data network gateway (PDN-GW), for reducing bearer creation or modification messages being exchanged in the EPS, the method comprising:
determining that a first UE of the plurality of UEs communicatively coupled to the eNodeB is congested; and
sending a first UE congestion status message destined for the PDN-GW, the first UE congestion status message indicating the first UE is congested.

16. The method of claim 15, wherein sending the first UE congestion status message further comprising:
generating a first Internet Protocol (IP) packet, wherein a congestion status of the first UE is contained in the first IP packet payload; and
sending the first IP packet destined for the PDN-GW.

17. The method of claim 15, wherein sending the first UE congestion status message further comprising:
generating a first GPRS Tunneling Protocol (GTP) packet, wherein a congestion status of the first UE is contained in a header field of the first GTP packet; and
sending the first GTP packet destined for the PDN-GW.

18. The method of claim 15, further comprising:
determining that the first UE communicatively coupled to the eNodeB is not congested; and
sending a second UE congestion status message destined for the PDN-GW, the second UE congestion status message indicating the first UE is not congested.

19. The method of claim 18, wherein sending the second UE congestion status message further comprising:
generating a second Internet Protocol (IP) packet, wherein a congestion status of the first UE is contained in the second IP packet payload; and
sending the second IP packet destined for the PDN-GW.

20. The method of claim 15, wherein sending the second UE congestion status message further comprising:
generating a second GPRS Tunneling Protocol (GTP) packet, wherein a congestion status of the first UE is contained in a header field of the second GTP packet; and
sending the second GTP packet destined for the PDN-GW.

21. An Evolved Node B (eNodeB) of a 3rd Generation Partnership Project (3GPP) Evolved Packet System (EPS), the EPS comprising a plurality of user equipments (UEs) communicatively coupled to a plurality of Evolved Node Bs (eNodeBs), the plurality of eNodeBs communicatively coupled to a packet data network gateway (PDN-GW), for reducing bearer creation or modification messages being exchanged in the EPS, the eNodeB comprising:
a network processor configured to determine whether one or more UEs of the plurality of UEs communicatively coupled to the eNodeB is congested;
the network processor further configured, for each UE determined to be congested, to send a first congestion status message destined for the PDN-GW, the first UE congestion status message indicating the corresponding UE is congested.

22. The eNodeB of claim 21, wherein the network processor is configured to send the first congestion status message destined for the PDN-GW by generating a first Internet Protocol (IP) packet, wherein a congestion status of the corresponding UE is contained in the first IP packet payload, and sending the first IP packet destined for the PDN-GW.

23. The eNodeB of claim 21, wherein the network processor is configured to send the first congestion status message destined for the PDN-GW by generating a first GPRS Tunneling Protocol (GTP) packet, wherein a congestion status of the corresponding UE is contained in a header field of the first GTP packet, and sending the first GTP packet destined for the PDN-GW.

24. The eNodeB of claim 21, wherein the network processor is further configured, for each UE determined to be not congested, to send a second congestion status message destined for the PDN-GW, the second UE congestion status message indicating the corresponding UE is not congested.

25. The eNodeB of claim 24, wherein the network processor is configured to send the second congestion status message destined for the PDN-GW by generating a second Internet Protocol (IP) packet, wherein a congestion status of the corresponding UE is contained in the second IP packet payload, and sending the second IP packet destined for the PDN-GW.

26. The eNodeB of claim 21, wherein the network processor is configured to send the second congestion status message destined for the PDN-GW by generating a second GPRS Tunneling Protocol (GTP) packet, wherein a congestion status of the corresponding UE is contained in a header field of the second GTP packet, and sending the second GTP packet destined for the PDN-GW.
